(19) United States
(12) Patent Application Publication
(10) Pub. No.: US 2018/0123935 A1
(43) Pub. Date: May 3, 2018

(54) Network Configuration Management System

(71) Applicant: ServiceNow, Inc., Santa Clara, CA (US)

(72) Inventors: Oren Ezer, Ramat Gan (IL); Haviv Rosh, Modiin (IL); Yuval Rimar, Petah Tikva (IL)

(73) Assignee: ServiceNow, Inc., Santa Clara, CA (US)

(21) Appl. No.: 15/338,506

(22) Filed: Oct. 31, 2016

(51) Int. Cl. H04L 12/26; H04L 12/24

(52) U.S. Cl. CPC H04L 43/12; H04L 41/12; H04L 43/106

(57) ABSTRACT

Systems and methods are disclosed for invoking a first discovery probe against a target device at a first time to obtain first probe data; determining a first hash value based at least in part on the first probe data; storing the first hash value, the stored first hash value associated with the first discovery probe and the first device; transmitting the first probe data to the server device; invoking the first discovery probe against the first device at a second time to obtain second probe data; determining a second hash value based at least in part on the second probe data; determining that a match has occurred, where the first hash value matches the second hash value; and, responsive to the match, transmitting an indication of no change, from the first probe data, to the server device.

### TECHNICAL FIELD

The present disclosure relates in general to a network configuration management system.

### BACKGROUND

Electronic computing and communications networks can be increasingly complex and difficult to manage as the networks scale to provide more services to more users. It can be helpful to allocate certain network management functions to an external service that specializes in these management functions. Such approaches, however, can lead to unnecessary traffic overhead and other network issues. Further, redundancies in the processes by which devices are discovered, tracked, and/or monitored in such an approach may further contribute to the network traffic overhead as well as to other network management issues.

### SUMMARY

Disclosed herein are implementations of apparatus and processes for a network configuration management system.

In an implementation, a system is provided for transmission of discovery probe data to a server device. The system may include a memory, a processor, and a network interface. The memory may store instructions executable by the processor to invoke a first discovery probe against a first device at a first time to obtain first probe data. The memory may store instructions executable by the processor to determine a first hash value based at least in part on the first probe data. The memory may store instructions executable by the processor to store the first hash value, the stored first hash value associated with the first discovery probe and the first device. The memory may store instructions executable by the processor to transmit, via the network interface, the first probe data to the server device. The memory may store instructions executable by the processor to invoke the first discovery probe against the first device at a second time to obtain second probe data. The memory may store instructions executable by the processor to determine a second hash value based at least in part on the second probe data. The memory may store instructions executable by the processor to determine whether the first hash value matches the second hash value. The memory may store instructions executable by the processor to, if it is determined that the first hash value matches the second hash value, transmit, via the network interface, an indication of no change, from the first probe data, to the server device. The memory may store instructions executable by the processor to, if it is determined that the first hash value does not match the second hash value, transmit, via the network interface, the second probe to the server device.

In an implementation, a system is provided for transmission of discovery probe data to a server device. The system may include a memory, a processor, and a network interface. The memory may store instructions executable by the processor to invoke a first discovery probe against a first device at a first time to obtain first probe data. The memory may store instructions executable by the processor to determine a first hash value based at least in part on the first probe data. The memory may store instructions executable by the processor to store the first hash value, the stored first hash value associated with the first discovery probe and the first device. The memory may store instructions executable by the processor to transmit, via the network interface, the first probe data to the server device. The memory may store instructions executable by the processor to invoke the first discovery probe against the first device at a second time to obtain second probe data. The memory may store instructions executable by the processor to determine a second hash value based at least in part on the second probe data. The memory may store instructions executable by the processor to determine that a match has occurred, where the first hash value matches the second hash value. The memory may store instructions executable by the processor to, responsive to the match, transmit, via the network interface, an indication of no change, from the first probe data, to the server device.

In an implementation, a method is provided for transmission of discovery probe data from to a server device. The method may include invoking a first discovery probe against a first device at a first time to obtain first probe data. The method may include determining a first hash value based at least in part on the first probe data. The method may include storing the first hash value, the stored first hash value associated with the first discovery probe and the first device. The method may include transmitting the first probe data to the server device. The method may include invoking the first discovery probe against the first device at a second time to obtain second probe data. The method may include determining a second hash value based at least in part on the second probe data. The method may include determining that a match has occurred, where the first hash value matches the second hash value. The method may include, responsive to the match, transmitting an indication of no change, from the first probe data, to the server device.

In an implementation, a non-transitory computer-readable storage medium is provided for transmission of discovery probe data from a remote agent device to a server device. The non-transitory computer-readable storage medium may include executable instructions that, when executed by a processor, facilitate performance of operations, including invoking a first discovery probe against a first device at a first time to obtain first probe data. The operations may include determining a first hash value based at least in part on the first probe data. The operations may include storing the first hash value, the stored first hash value associated with the first discovery probe and the first device. The operations may include transmitting the first probe data to a server device. The operations may include invoking the first discovery probe against the first device at a second time to obtain second probe data. The operations may include determining a second hash value based at least in part on the second probe data. The operations may include determining that a match has occurred, where the first hash value matches the second hash value. The operations may include, responsive to the match, transmitting an indication of no change, from the first probe data, to the server device.

In an implementation, a system is provided for transmission of discovery probe data to a server device. The system may include a memory, a processor, and a network interface. The memory may store instructions executable by the processor to invoke a first discovery probe against a first device at a first time to obtain first probe data. The memory may store instructions executable by the processor to determine a first hash value based at least in part on the first probe data. The memory may store instructions executable by the processor to store the first hash value for later comparison to a hash value for a future probe data, the stored first hash value associated with the first discovery probe and the first device.

These and other aspects of the present disclosure are disclosed in the following detailed description, the appended claims, and the accompanying figures.

### BRIEF DESCRIPTION OF THE DRAWINGS

The description herein makes reference to the accompanying drawings, wherein like reference numerals refer to like parts throughout the several views.

FIG. 1 is a diagram of an example of an electronic computing and communications system.

FIG. 2 is a block diagram of an example internal configuration of a computing device of the electronic computing and communications system shown in FIG. 1.

FIG. 3 is a logic flowchart illustrating an example of a method for determining the configuration and/or status of a target device in a network and transmitting this data to a server device.

FIG. 4 is a logic flowchart illustrating an example of a method for determining the configuration and/or status of a target device.

FIG. 5 is a diagram of example communications to update a network model in an example electronic computing and communications system.

FIG. 6 is a memory map showing an example format for a record stored in a cache for discovery probe data.

FIG. 7 is a memory map showing an example format for a record stored in a cache for results of discovery probe steps.

### DETAILED DESCRIPTION

This document includes disclosure of systems, apparatus, and methods for gathering configuration and status information from computing devices in a network under management from a remote location. A system managing a remote network may maintain a model of the network under management (e.g., data representing important characteristics of the network), including models of the resources (e.g., devices and services) available within the network. A model of a device may be updated from time to time by querying the device to determine its current status and configuration. A discovery probe may be invoked against the device to gather this information from the device. In some implementations, the discovery probe can be invoked by software executing on an agent device within or connected to the remote network.

Completing a discovery probe of a device and transmitting the resulting data to a server device may consume a number of network resources. For example, responding to a discovery probe may occupy some or all of the resources of the target device during the response interval as it responds to queries in the form of discovery probe steps and, thus, may prevent the device from performing other functions for which it is intended during this interval. Gathering the data resulting from a discovery probe and transmitting the data to a server device may also consume some or all of a limited amount of available network bandwidth, both within the network under management and on a link to external networks and/or the server device. For example, the routine or periodic sending of data reflecting results of a completed discovery probe to a management software running on a server device may cause unnecessary interruptions to the network (e.g., a customer instance, communication line, database, etc.).

In accordance with the present approach, the consumption of network resources by discovery probes may be reduced by avoiding transmission of discovery probe data that matches data resulting from previous invocation of the same discovery probe against the same target device. In some implementations, the resulting probe data may be input to a hash function (or otherwise transformed and/or summarized), and the resulting hash values may be stored between discovery probe invocations and compared to determine whether the probe data has changed since a previous invocation of the discovery probe against the same device. In some implementations, the consumption of network resources by discovery probes is reduced by caching the results of discovery probe steps to avoid repeating the same query of a device too frequently.

A discovery probe can include one or more steps that can be run against a device in order to discover the status and/or configuration of that device. In an implementation, a discovery probe can be implemented using a discovery pattern expressed in a domain-specific discovery language or other language that can be used to describe the information discovery step(s) of the pattern. The discovery pattern can be interpreted to identify the commands to be performed when a discovery step is invoked. In some implementations, the interpretation of a discovery pattern can take place on the agent device, the server device, or a combination thereof.

A network management system may obtain or create a discovery probe from templates that are configured to communicate with a device using, for example, a compatible language or interface (e.g., secure shell (SSH), Windows Management Instrumentation (WMI), etc.). For example, a step can be implemented using SSH and a template command (e.g., ipconfig) and information specific to the device (e.g., network address and authentication information). When the step is invoked, the device can be logged into using SSH and information about the device retrieved, such as by executing the command or retrieving a file.

For example, the steps of a discovery probe may request information about the device, such as its operating system name and version, or involve setting configurations, such as for directories or connections to other network resources. Different discovery probes may be set up for discovering different types of devices. In some cases, different probes may perform the same or a similar step for different purposes. Such redundancy with respect to the repeated step(s) can result in unnecessary traffic overhead and other network issues. By way of example, network traffic may be generated by execution of a redundant step of a respective discovery probe even though the information gathered by the step in question has already been retrieved by an earlier occurrence of the step in association with a different discovery probe. For example, where a step is being run against the same device, the information that is retrieved by that step for different discovery probes may be the same, such as where the underlying information changes infrequently.

In some implementations, a management system may include management software (which may be called a platform instance) running on a server device. In some implementations, a model of a device may be stored as a data structure (which may be called a configuration item or CI) that is stored in a configuration management database (CMDB) running on a database server.

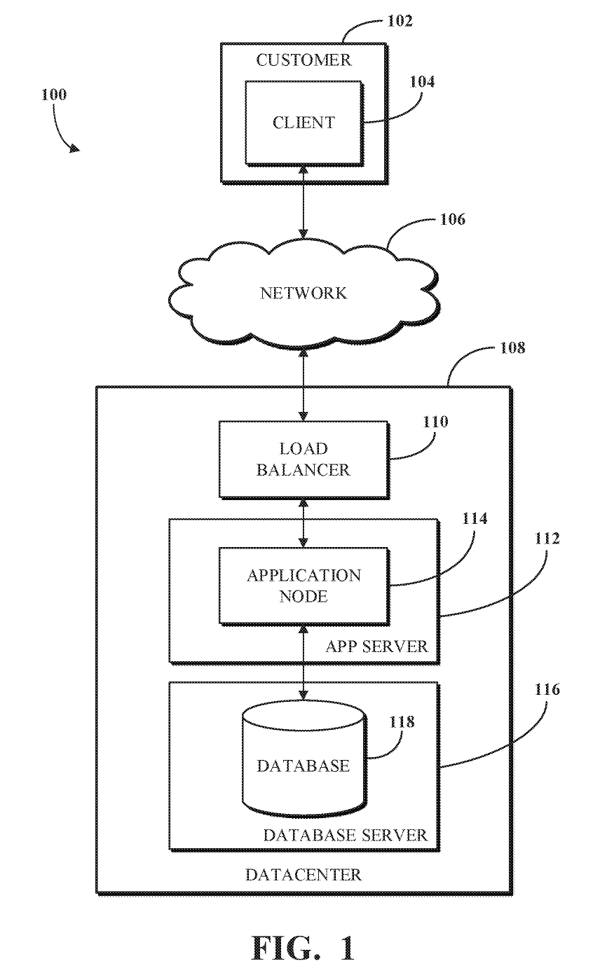

To describe some implementations in greater detail, reference is first made to examples of hardware structures. FIG. 1 is a diagram of an example of an electronic computing and communications system 100. As used herein, the term “electronic computing and communications system,” or variations thereof, can be, or include, a distributed computing system, such as a client-server computing system, a cloud computing system, a clustered computing system, or the like.

The system 100 can include one or more customers 102. The customer 102 can include one or more clients. For example, and without limitation, the customer 102 can include a client 104. The client 104 can comprise a computing system, which can include one or more computing devices, such as a mobile phone, a tablet computer, a laptop computer, a notebook computer, a desktop computer, or any other suitable computing device or combination of computing devices. In some implementations, the client 104 can be implemented as a single physical unit, or as a combination of physical units. In some implementations, a single physical unit can include multiple clients.

In some implementations, the client 104 can be an instance of an application running on a customer device associated with the customer 102. As used herein, the term “application” can include, but is not limited to, applications, programs, instances, processes, threads, services, plugins, patches, application version upgrades, and/or any other identifiable computational aspect. The system 100 can include any number of customers and/or clients and/or can have a configuration of customers and/or clients different from that generally illustrated in FIG. 1. For example, and without limitation, the system 100 can include hundreds or thousands of customers, and at least some of the customers can include and/or be associated with any number of clients. A customer can include a customer network and/or domain. For example, and without limitation, the client 104 can be associated and/or communicate with a customer network and/or domain.

The system 100 can include a datacenter 108. The datacenter 108 can include one or more servers. For example, and without limitation, the datacenter 108, as generally illustrated, includes an application server 112 and a database server 116. A datacenter, such as the datacenter 108, can represent a geographic location, which can include a facility, where the one or more servers are located. The system 100 can include any number of datacenters and servers and/or can include a configuration of datacenters and servers different from that generally illustrated in FIG. 1. For example, and without limitation, the system 100 can include tens of datacenters, and at least some of the datacenters can include hundreds or any suitable number of servers. In some implementations, the datacenter 108 can be associated and/or communicate with one or more datacenter networks and/or domains, which can include domains other than the customer domain.

In some implementations, the client 104 and the servers associated with the datacenter 108 are configured to connect to, or communicate via, a network 106. In some implementations, a client 104 associated with the customer 102 can connect to the network 106 via a communal connection point, link, and/or path. In some implementations, a client 104 associated with the customer 102 can connect to, or communicate via, the network 106 using a distinct connection point, link, and/or path. A connection point, link, or path can be wired, wireless, or a combination thereof.

In some implementations, the network 106 can include, for example, the Internet. In some implementations, the network 106 can be, or include, a local area network (LAN), a wide area network (WAN), a virtual private network (VPN), or any other public or private means of electronic computer communication capable of transferring data between a client, such as the client 104, and one or more servers associated with the datacenter 108, and/or any combination thereof. The network 106, the datacenter 108, or any other element, or combination of elements, of the system 100 can include network hardware such as routers, switches, load balancers, other network devices, or combinations thereof. For example, the datacenter 108 can include a load balancer 110 for routing traffic from the network 106 to various servers associated with the datacenter 108.

The load balancer 110 can route, or direct, computing communication traffic, such as signals and/or messages, to respective elements of the datacenter 108. For example, the load balancer 110 can operate as a proxy, or reverse proxy, for a service, such as an Internet-delivered service, provided by the datacenter 108 to one or more remote clients, such as the client 104, via the network 106. Routing functions of the load balancer 110 can be configured directly or via a Domain Name System (DNS). The load balancer 110 can coordinate requests from remote clients, such as the client 104, and can simplify client access by masking the internal configuration of the datacenter 108 from the remote clients. Request coordination can include maintaining information for sessions, such as sticking sessions, between a client and a service or application provided by the datacenter 108.

In some implementations, maintaining information for a sticky session can include maintaining information to forward requests associated with a session from a client to an identified element of the datacenter 108 for the session. A load balancer 110 can operate as a firewall, allowing or preventing communications based on configuration settings. Although the load balancer 110 is depicted in FIG. 1 as being within the datacenter 108, in some implementations, the load balancer 110 can instead be located outside of the datacenter 108, for example, when providing global routing for multiple datacenters. In some implementations, load balancers can be included both within and outside of the datacenter 108.

In some implementations, the datacenter 108 includes an application server 112 and a database server 116. The application server 112 and/or the database server 116 can be a computing system, which can include one or more computing devices, such as a desktop computer, a server computer, or any other computer capable of operating as a server. In some implementations, the application server 112 and/or the database server 116 can be non-hardware servers implemented on a physical device, such as a hardware server. In some implementations, the application server 112 and the database server 116 can be implemented as a single hardware server or as a single non-hardware server implemented on a single hardware server. In some implementations, any number of application servers or database servers can be implemented at the datacenter 108. In some implementations, the datacenter 108 can include servers other than or in addition to the application server 112 or the database server 116, for example, a web server.

In some implementations, the application server 112 includes an application node 114, which can be a process executed on the application server 112. For example, and without limitation, the application node 114 can be executed in order to deliver services to a client, such as the client 104, as part of a web application. The application node 114 can be implemented using processing threads, virtual machine instantiations, or other computing features of the application server 112. In some implementations, the application node 114 can store, evaluate, or retrieve data from a database, such as the current database 118 of the database server 116.

In some implementations, the application server 112 can include any suitable number of application nodes, depending upon a system load and/or other characteristics associated with the application server 112. For example, and without limitation, the application server 112 can include two or more nodes forming a node cluster. In some implementations, the application nodes implemented on a single application server 112 can run on different hardware servers.

The database server 116 can be configured to store, manage, or otherwise provide data for delivering services to the client 104 over a network. In some implementations, the database server 116 includes a data storage unit, such as a current database 118, which can be accessible by an application executed on the application server 112. In some implementations, the current database 118 can be implemented as a relational database management system (RDBMS), an object database, an XML database, a configuration management database (CMDB), a management information base (MIB), one or more flat files, or the like, or a combination thereof. By way of non-limiting example, the system 100, in some implementations, can include an XML database and a CMDB. While limited examples are described, the current database 118 can be configured as and/or comprise any suitable database type. Further, the system 100 can include one, two, three, or any suitable number of databases configured as and/or comprising any suitable database type and/or combination thereof.

In some implementations, the database 118 can be configured as and/or comprise a CMDB. A CMDB can store or reference a plurality of configuration items (CIs). A CI can be a CMDB record that represents an infrastructure entity, device, and/or units of the system 100. For example, the customer 102, the client 104, the network 106, the datacenter 108, the load balancer 110, the application server 112, the application node 114, the database server 116, the current database 118, or any other element, portion of an element, or combination of elements of the electronic computing and communications system 100 can be represented in the CMDB by a CI.

The CMDB can include information describing the configuration, the role, or both, of an element of the system 100. In some implementations, an MIB can include one or more databases listing characteristics of the elements of the system 100. In some implementations, an object identifier (OID) can represent object identifiers of objects or elements in the MIB.

In some implementations, one or more databases (e.g., the current database 118), tables, other suitable information sources, and/or portions or combinations thereof, can be stored, managed, or otherwise provided by one or more of the elements of the system 100 other than the database server 116, such as the client 104 and/or the application server 112.

Some or all of the systems and methods described herein can operate and/or be executed on or by the servers associated with the system 100. In some implementations, the systems and methods described herein, portions thereof, or combinations thereof, can be implemented on a single device, such as a single server, or a combination of devices, for example, a combination of the client 104, the application server 112, and the database server 116.

In some implementations, the system 100 can include devices other than the client 104, the load balancer 110, the application server 112, and the database server 116 as generally illustrated in FIG. 1. In some implementations, one or more additional servers can operate as an electronic computing and communications system infrastructure control, from which servers, clients, and/or both, can be monitored, controlled, configured, or a combination thereof.

In some implementations, the network 106, one or more datacenters, such as the datacenter 108, and one or more load balancers, such as the load balancer 110, can be implemented within a distributed computing system. In some implementations, a load balancer associated with a distributed computing system (e.g., the load balancer 110) can communicate with the network 106, one or more datacenters (e.g., the datacenter 108), other load balancers, or a combination thereof. Although illustrated as a single unit in FIG. 1, a load balancer 110 can be implemented as multiple physical or logical units. For example, a distributed computing system can include distinct routing units, load balancing units, firewall units, or the like.

The primary datacenter can include a primary database, such as the current database 118, and the secondary datacenter can include a secondary database. In some implementations, the secondary database can include an exact or substantially exact mirror, copy, or replication of the primary database. In some implementations, the primary database and/or the secondary database can be implemented as a relational database management system (RDBMS), an object database, an XML database, one or more flat files, or the like.

An application node implemented within a distributed computing environment can connect to and/or communicate with the primary database, which can be associated with the datacenter with which the application node is associated, and/or associated with another datacenter. For example, a primary datacenter can include a primary database and a first set of application nodes. A secondary datacenter can include a secondary database and a second set of application nodes. The application nodes of the first and second sets can provide a service or application to remote clients, and can read and/or write data in the primary database. The secondary database can mirror changes made to the primary database and prevent write operations from being performed directly on the secondary database. In the event that a failover condition associated with the primary database is identified, the secondary database can operate as the primary database and can allow read and/or write access to data. The primary database can then operate as the secondary database, mirror the new primary database, and prevent direct write access to the new secondary database.

In some implementations, a distributed computing system can allocate resources of a computer network using a multi-tenant or single-tenant architecture. Allocation of resources in a multi-tenant architecture can include installations and/or instantiations of one or more servers, such as application servers, database servers, and/or any other server, or combination of servers, that can be shared amongst multiple customers. For example, a web server, such as a unitary Apache installation; an application server, such as a unitary Java Virtual Machine; or a single database server catalog, such as a unitary MySQL catalog, can handle requests from multiple customers. In some implementations of a multi-tenant architecture, the application server, the database server, and/or both can distinguish between and segregate data and/or other information of the various customers using the system.

In a single-tenant infrastructure (which can also be referred to as a multi-instance architecture), separate web servers, application servers, database servers, and/or combinations thereof can be provisioned for at least some customers and/or customer sub-units. In some implementations, customers and/or customer sub-units can access one or more dedicated web servers, have transactions processed using one or more dedicated application servers, and/or have data stored in one or more dedicated database servers, catalogs, and/or both. Physical hardware servers can be shared such that multiple installations and/or instantiations of web servers, application servers, database servers, and/or combinations thereof can be installed on the same physical server. An installation can be allocated a portion of the physical server resources, such as RAM, storage, communications bandwidth, and/or processor cycles.

In some implementations, a customer instance can include multiple web server instances, multiple application server instances, multiple database server instances, and/or a combination thereof. The server instances can be physically located on different physical servers and can share resources of the different physical servers with other server instances associated with other customer instances. In a distributed computing system, multiple customer instances can be used concurrently. Other configurations and/or implementations of customer instances can also be used. The use of customer instances in a single-tenant architecture can provide, for example, true data isolation from other customer instances, advanced high availability to permit continued access to customer instances in the event of a failure, flexible upgrade schedules, an increased ability to customize the customer instance, and/or a combination thereof.

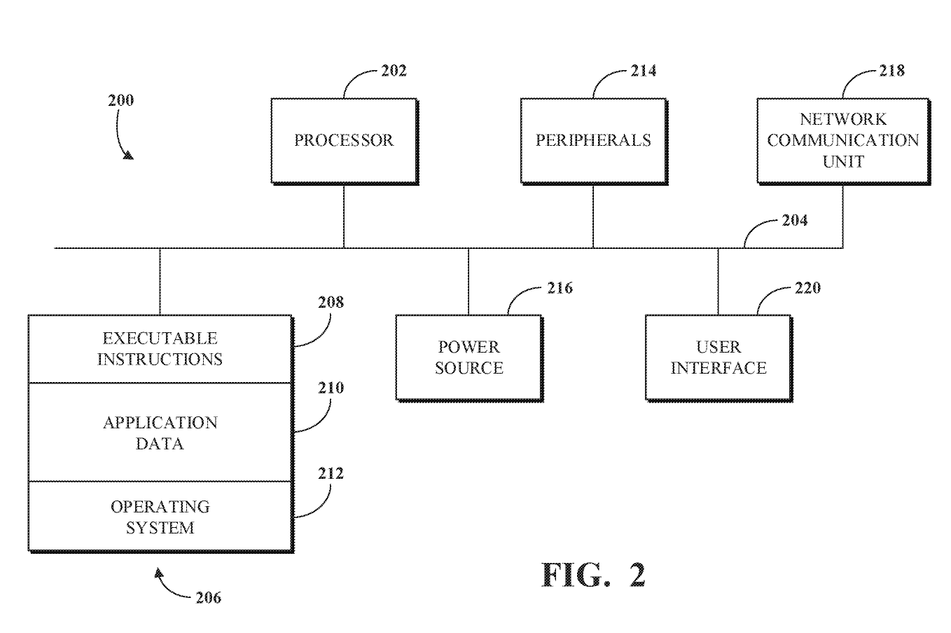

FIG. 2 generally illustrates a block diagram of an example internal configuration of a computing device 200, such as a client 104 and/or a server, such as an application server 112 and/or a database server 116, of the electronic computing and communications system 100 as generally illustrated in FIG. 1. As previously described, a client and/or server can be a computing system including multiple computing devices and/or a single computing device, such as a mobile phone, a tablet computer, a laptop computer, a notebook computer, a desktop computer, a server computer, and/or other suitable computing devices.

A computing device 200 can include components and/or units, such as a processor 202, a bus 204, a memory 206, peripherals 214, a power source 216, a network communication unit 218, a user interface 220, other suitable components, and/or any combination thereof.

The processor 202 can be a central processing unit (CPU), such as a microprocessor, and can include single or multiple processors, having single or multiple processing cores. Alternatively, the processor 202 can include another type of device, or multiple devices, now existing or hereafter developed, capable of manipulating or processing information. For example, the processor 202 can include multiple processors interconnected in any manner, including hardwired and/or networked, including wirelessly networked. In some implementations, the operations of the processor 202 can be distributed across multiple physical devices and/or units that can be coupled directly or across a local area or other type of network. In some implementations, the processor 202 can include a cache, or cache memory, for local storage of operating data and/or instructions. The operations of the processor 202 can be distributed across multiple machines, which can be coupled directly or across a local area or other type of network.

In some implementations, the memory 206 can include volatile memory, non-volatile memory, and/or a combination thereof. For example, the memory 206 can include volatile memory, such as one or more DRAM modules, such as DDR SDRAM, and non-volatile memory, such as a disk drive, a solid state drive, flash memory, Phase-Change Memory (PCM), and/or any form of non-volatile memory capable of persistent electronic information storage, such as in the absence of an active power supply. In some implementations, the memory 206 can include another type of device, or multiple devices, now existing or hereafter developed, capable of storing data and/or instructions for processing by the processor 202. The processor 202 can access and/or manipulate data in the memory 206 via the bus 204. Although shown as a single block in FIG. 2, the memory 206 can be implemented as multiple units. For example, a computing device 200 can include volatile memory, such as RAM, and persistent memory, such as a hard drive or other storage. The memory 206 can be distributed across multiple machines, such as network-based memory or memory in multiple machines performing the operations of clients and/or servers.

The memory 206 can include executable instructions 208; data, such as application data 210; an operating system 212; or a combination thereof for immediate access by the processor 202. The executable instructions 208 can include, for example, one or more application programs, which can be loaded and/or copied, in whole or in part, from non-volatile memory to volatile memory to be executed by the processor 202. The executable instructions 208 can be organized into programmable modules and/or algorithms, functional programs, codes, code segments, and/or combinations thereof to perform various functions described herein. For example, the executable instructions 208 can include instructions to: use and/or access multiple caches to reduce the overhead involved in processing one or more discovery patterns on a network and to reduce the amount of queries run against one or more devices on the network by the discovery pattern(s). The application data 210 can include, for example, user files; database catalogs and/or dictionaries; configuration information or functional programs, such as a web browser; a web server; a database server; and/or a combination thereof. The operating system 212 can be, for example, Microsoft Windows®, Mac OS X®, or Linux®; an operating system for a small device, such as a smartphone or tablet device; or an operating system for a large device, such as a mainframe computer. The memory 206 can comprise one or more devices and can utilize one or more types of storage, such as solid state or magnetic storage.

The peripherals 214 can be coupled to the processor 202 via the bus 204. The peripherals can be sensors or detectors, or devices containing any number of sensors or detectors, which can monitor the computing device 200 itself and/or the environment around the computing device 200. In some implementations, a client and/or server can omit the peripherals 214. In some implementations, the power source 216 can be a battery, and the computing device 200 can operate independently of an external power distribution system. Any of the components of the computing device 200, such as the peripherals 214 or the power source 216, can communicate with the processor 202 via the bus 204. Although depicted here as a single bus, the bus 204 can be composed of multiple buses, which can be connected to one another through various bridges, controllers, and/or adapters.

The network communication unit 218 can also be coupled to the processor 202 via the bus 204. In some implementations, the network communication unit 218 can comprise one or more transceivers. The network communication unit 218 can, for example, provide a connection or link to a network, such as the network 106, via a network interface, which can be a wired network interface, such as Ethernet, or a wireless network interface. For example, the computing device 200 can communicate with other devices via the network communication unit 218 and the network interface using one or more network protocols, such as Ethernet, TCP, IP, power line communication (PLC), Wi-Fi, infrared, GPRS, GSM, CDMA, or other suitable protocols.

A user interface 220 can include a display; a positional input device, such as a mouse, touchpad, touchscreen, or the like; a keyboard; and/or any other human and machine interface devices. The user interface 220 can be coupled to the processor 202 via the bus 204. Other interface devices that permit a user to program or otherwise use the computing device 200 can be provided in addition to or as an alternative to a display. In some implementations, the user interface 220 can include a display, which can be a liquid crystal display (LCD), a cathode-ray tube (CRT), a light emitting diode (LED) display (e.g., an OLED display), or other suitable display.

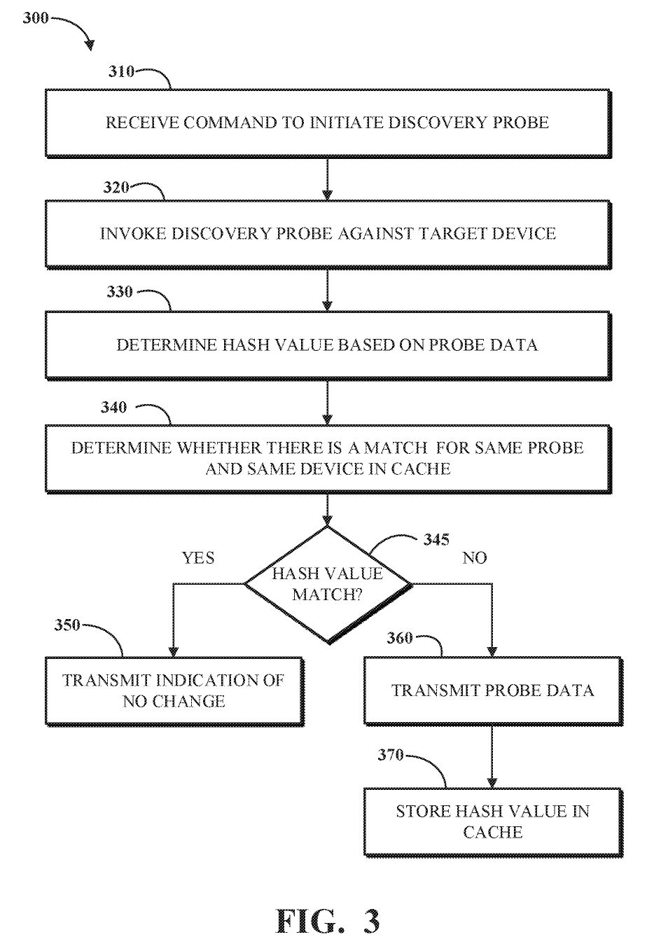

FIG. 3 is a flowchart of a technique 300 for determining the configuration and/or status of a target device in a network and transmitting this data to a server device in an electronic computing and communications system, such as the system 100 of FIG. 1. In some implementations, the technique 300 can be executed using computing devices, such as the systems, modules, and devices described with respect to FIGS. 1, 2, and 5. In some implementations, the technique 300 can be performed, for example, by executing a machine-readable program or other computer-executable instructions, such as instructions or programs described according to JavaScript, C, or other such instructions. The operations, of the technique 300 or any other method, process, or algorithm described in connection with the implementations disclosed herein can be implemented directly in hardware, firmware, software executed by hardware, circuitry, and/or a combination thereof. For example, the technique 300 may be implemented by a remote agent software instance running on a remote agent device within a network under management.

A discovery probe may be invoked against the target device to gather information from the target device. For example, a discovery probe can include one or more steps that can be invoked against a target device in order to discover the status and/or configuration of that target device. A network management system may obtain or create a discovery probe from templates that are configured to communicate with a target device using, for example, a compatible language or interface (e.g., secure shell (SSH), Windows Management Instrumentation (WMI), etc.). For example, a step can be implemented using SSH and a template command (e.g., ipconfig) and information specific to the target device (e.g., network address and authentication information). When the step is invoked, the device can be logged into using SSH and information about the device retrieved, such as by executing the command or retrieving a file. For example, the steps of a discovery probe may request information about the target device, such as its operating system name and version, or involve setting configurations, such as for directories or connections to other network resources. Different discovery probes may be set up for discovering different types of target devices. The information gathered using a discovery probe may be used populate or update a CI stored in CMDB (e.g., as in the database 118) which in turn may facilitate management of a customer environment or network (e.g., the customer 102) in which a target device operates.

In some implementations, technique 300 can include receiving 310 a command to initiate a discovery probe against a target device. For example, the command may be received 310 from a server device that is configured to manage the network in which the target device operates. The command may be issued to a remote agent device running a remote agent software instance within the network under management. In some implementations, a command may only be issued to the remote agent device when the remote agent first establishes a session or connection with a server to request commands. In some implementations, no command is received at the time a discovery probe is initiated, and instead the discovery probe is initiated when a timer expires or upon the occurrence of some other triggering event. The command may be received 310 from a server device via a network interface of a device implementing the technique 300.

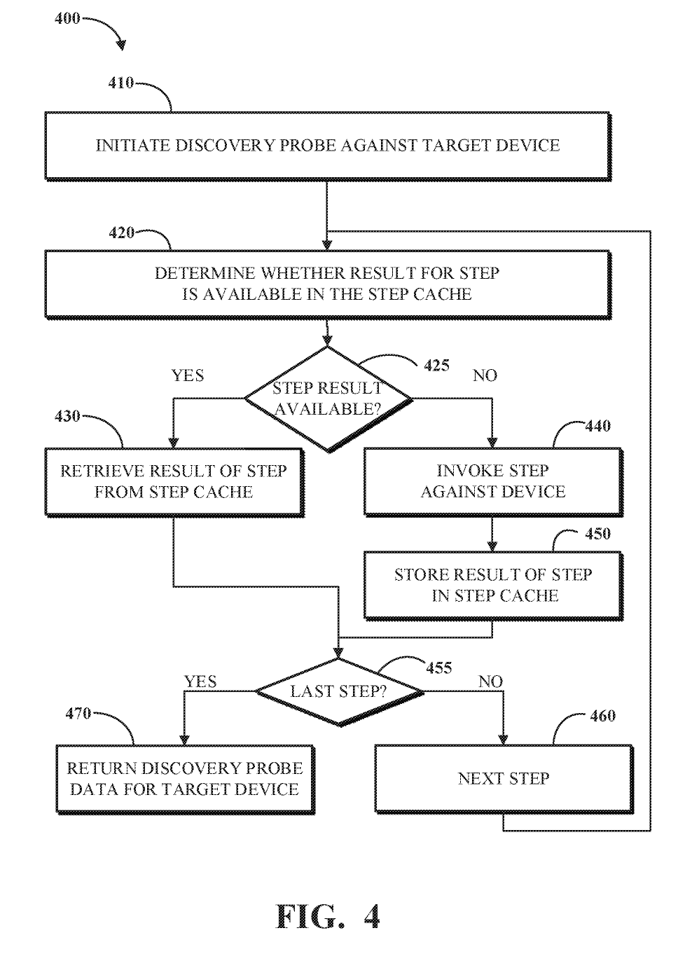

The technique 300 may include invoking 320 a discovery probe against a target device in a network under management. In some implementations, each step of the discovery probe is invoked against the target device and the results for each step are received from the target device. In some implementations, a step cache is interposed between a module invoking the steps of the discovery probe and the target device. Some steps of the discovery probe that have been previously invoked against the target device within a threshold period of time may optionally not be invoked against the device. Instead the results for those steps may be retrieved from the step cache. Other steps of the discovery probe that have not been invoked against the target device within a threshold period of time before the current invocation may be invoked against the target device, and the corresponding results may be received from the target device. For example, the technique 400 described in relation to FIG. 4 may be used to invoke 320 a discovery probe with an interposed step cache.

In some implementations, a processor invoking 320 a discovery probe may execute instructions to communicate with the target device directly and retrieve configuration and/or status information from the target device. In some implementations, a processor invoking 320 a discovery probe may call on or instruct another processor to execute instructions to communicate with the target device and retrieve configuration and/or status information from the target device.

Once data representing the results for the steps of a discovery probe have been received or retrieved from a step cache, a hash value may be determined 330 based on this collection of probe data. For example, the results data may be serialized and input to a hash function or hash map with the corresponding output returned as the hash value for that probe data. In some implementations, the hash value for a probe data may be based in part on an identifier of the discovery probe and an identifier of the target device. For example, an identifier of the discovery probe invoked and/or an identifier (e.g., a MAC address) of the target device against which the discovery probe was invoked may be serialized with the resulting probe data and input to a hash function or hash map with the corresponding output returned as the hash value for that probe data.

Whether the new probe data matches a previously transmitted probe data from the target device may be determined 340 based on the new hash value determined for the new probe data. The new hash value may be compared to one or more stored hash values for previous invocations of a discovery probe. For example, the hash values for the previous invocations of a discovery probe may be stored in a hash cache data structure. If a previous hash value is equal to the new hash value, it may be determined 340 that the corresponding probe data matches and thus that data for a model of the target device maintained by a platform instance running on a server device is already current and transmission of the complete probe data is unnecessary.

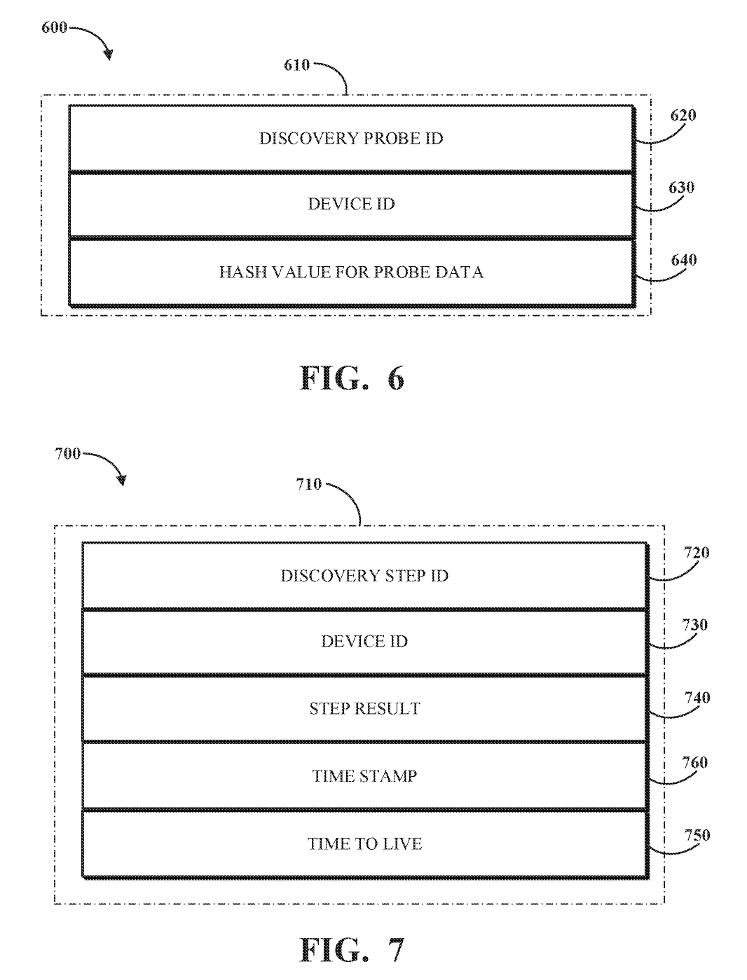

In some implementations, previous hash values are stored in a record that includes fields that identify the discovery probe and the target device corresponding to the old hash value, for example, as described in relation to FIG. 6. The hash cache may be searched to find the last hash value for the same discovery probe and the same target device. This last hash value may be compared to the new hash value to determine 340 whether the new probe data matches the most recent probe data for the target device. In some implementations, the hash cache is structured as a hash table using a key that is based on an identifier of a discovery probe and an identifier of a target device. The hash cache may be searched for the relevant previous hash value by invoking a hash table look-up. The hash table look-up may be invoked using a key that is based on an identifier of the discovery probe and an identifier of the target device, in order to retrieve the most recent relevant stored hash value for comparison to the new hash value. If the last hash value is equal to the new hash value, it may be determined 340 that the corresponding probe data matches. If no corresponding record is found in the hash cache, or if the last hash value is not equal to the new hash value, it may be determined 340 that the corresponding probe data does not match.

In some implementations, hash values are based in part on identifiers of the discovery probe invoked and the target device against which the discovery probe was invoked. Previous hash values may be stored in a hash cache in records lacking fields that separately identify a discovery probe invoked or a target device. The new hash value may be compared to previous hash values in the hash cache. If the new hash value is equal to a stored hash value, then a match is determined 340 to have occurred. If the new hash value is not equal to any of the stored hash values, then a match is determined 340 not to have occurred.

If (as determined at decision operation 345) a hash value match has occurred, then an indication of no change may be transmitted 350 to a platform instance running on a server device that manages the network including the target device. For example, the indication of no change may include an identifier of the discovery probe, an identifier of the target device, and timing information to indicate that the data for the discovery probe for the target device is current as of a specified time. In some implementations, the indication of no change may identify a command received from the server device to which the indication of no change is responsive. When an indication of no change is transmitted 350, transmission of the new probe data may be unnecessary. In some implementations, the indication of no change is transmitted 350 instead of the new probe data. The indication of no change may be transmitted 350 to a server device via a network interface of a device implementing technique 300.

If (as determined at decision operation 345) a hash value match has not occurred, then the new probe data may be transmitted 360 to a platform instance running on a server device that manages the network including the target device. In some implementations, the probe data may identify a command received from the server device to which the probe data is responsive. The probe data may be transmitted 360 to a server device via a network interface of a device implementing technique 300.

The new hash value generated for the new probe data may be stored 370. The new hash value may be stored 370 in a hash cache data structure, for example, including records described in relation to FIG. 6. If a previous record associated with the same discovery probe and target device was found in the hash cache but the hash value did not match, the new hash value may be stored 370 by overwriting and replacing the older hash value. A hash cache may be stored in the memory of a device implementing the technique 300. In some implementations, a hash cache is stored on a separate memory storage device, such as a database server.

Although the technique 300 is shown as a series of operations for clarity, implementations of the technique 300 or any other method, technique, process, and/or algorithm described in connection with the implementations disclosed herein can be performed in various orders and/or concurrently. Additionally, operations in accordance with this disclosure can be performed with other operations not presented and described herein. For example, the operations may further include encrypting and/or compressing discovery probe data or other communications between a server device and a remote agent device prior to transmission across a network. For example, in an implementation, decision operation 425 can be enabled or disabled for individual steps based on a step configuration. For example, operation 345 can be overridden to transmit probe data when there is or may be a hash value match upon the occurrence of defined criteria. Furthermore, one or more aspects of the systems and techniques described herein can be omitted.

FIG. 4 is a flowchart of a technique 400 for invoking a discovery probe, through a step cache, against a target device in an electronic computing and communications system, such as the system 100 of FIG. 1. In some implementations, the technique 400 can be executed using computing devices, such as the systems, modules, and devices described with respect to FIGS. 1, 2, and 5. In some implementations, the technique 400 can be performed, for example, by executing a machine-readable program or other computer-executable instructions, such as instructions or programs described according to JavaScript, C, or other such instructions. The operations of the technique 400 or any other method, process, or algorithm described in connection with the implementations disclosed herein can be implemented directly in hardware, firmware, software executed by hardware, circuitry, and/or a combination thereof.

In some implementations, the technique 400 can include initiating 410 a discovery probe against a target device. For example, code for implementing the discovery probe may be retrieved or generated based on an identifier of the discovery probe. In some implementations, code for implementing the discovery probe may be selected or generated based in part on an identifier of the target device and/or information about a type of the target device. The steps of the discovery probe may be arranged in a sequence, and the first step to be performed may be identified when the discovery probe is initiated 410. In some implementations, the discovery probe is initiated 410 in response to a command received from a platform instance running on a server device. In some implementations, the discovery probe is initiated 410 when a timer expires or upon the occurrence of some other triggering event.

For a current step of the discovery probe, a determination is made at operation 420 of whether a result for the step is available in a step cache, which stores results of discovery steps. The availability of a result for the step may be determined 420 by searching the step cache for a record corresponding to the same step and the same target device. For example, the step cache may be stored in a format described in relation to FIG. 7. In some implementations, records in the step cache may be associated with a time to live, after which the corresponding result stored in the step cache record expires and is no longer available for retrieval. A step result record found during a search may be checked to determine if its associated time to live has expired. If a record for the same step and same target device is found in the step cache and the record has not expired, then the step result may be determined 420 to be available. If no record for the same step and same target device is found or if all records found have expired, then the step result may be determined 420 to be unavailable.

If (as determined at decision operation 425) a result for the step is available in the step cache, then the stored step result is retrieved 430 from the step cache. This stored step result may be returned as part of the probe data for this invocation of the discovery probe. In some implementations, the step result may be retrieved 430 instead of invoking the step against the target device.

If (as determined at decision operation 425) a result for the step is not available in the step cache, then the current step is invoked 440 against the target device. In some implementations, a processor invoking 440 a discovery probe step may execute instructions to communicate with the target device directly and retrieve configuration and/or status information from the target device. In some implementations, a processor invoking 440 a discovery probe step may call on or instruct another processor to execute instructions to communicate with the target device and retrieve configuration and/or status information from the target device. For example, a provider can be invoked, such as an SSH provider or a WMI provider, to communicate with the target device and receive information from the target device.

The new result of the step received from the target device may then be stored 450 in the step cache. In some implementations, the result of the step is associated with a time to live, after which this new step result will no longer be available for retrieval. In some implementations, a time to live for a step result may be determined based on the discovery probe step or a step type classification. In this manner, discovery can have individually configured refresh rates tailored to the nature of the information gathered by that discovery probe step. For example, a step querying the operating system of a target device may have a different (e.g., longer) time to live for its results in the step cache than another step querying the processor usage of the target device. In some implementations, a time to live for a step result may be determined based on an identification of the target device or a target device type classification. In this manner, discovery can have individually configured refresh rates tailored to the nature of the target devices being discovered. For example, a step result for a target device that is a network switch may have a different (e.g., longer) time to live for its results in the step cache than another step result for a target device that is a load balancer. For example, the new result of the step received from the target device may then be stored 450 in the step cache in a record using the format described in relation to FIG. 7.

A step cache may be stored in the memory of a device implementing the technique 400. In some implementations, a step cache is stored on a separate memory storage device, such as a database server.

If (as determined at decision operation 455) this was not the last step of the discovery probe, then the next step of the discovery probe to be performed is determined 460 and processed in turn. If (as determined at decision operation 455) this was the last step of the discovery probe, then discovery probe data, including step results retrieved from the step cache and/or received from the target device, is returned 470. For example, the probe data may be returned 470 to a module running on the same remote agent device that invoked the discovery probe.

Although the technique 400 is shown as a series of operations for clarity, implementations of the technique 400 or any other method, technique, process, and/or algorithm described in connection with the implementations disclosed herein can be performed in various orders and/or concurrently. Additionally, operations in accordance with this disclosure can be performed with other operations not presented and described herein. For example, the operations may include periodically flushing the step cache to access the most current data for devices in a customer environment. For example, in an implementation, caching can be enabled or disabled for individual steps based on a step configuration. Furthermore, one or more aspects of the systems and techniques described herein can be omitted.

In some implementations, portions of techniques 300 and/or 400 can be implemented using a dynamic proxy. In such an implementation, modules for invoking discovery probes against devices and returning information retrieved using the discovery probes may have been previously implemented. In such an implementation, a request to invoke a discovery probe can be intercepted by or redirected to a module implementing technique 400, transmission of information retrieved from a discovery probe may be intercepted by or redirected to a module implementing portions of technique 300, or combinations thereof. In an example, a dynamic proxy intercepting a discovery probe can be configured to return information from the step cache thus preventing the discovery probe from being executed against a target device. In an example, a dynamic proxy intercepting a transmission of information can transmit an indication that there is no change in the information from the discovery probe instead of the actual information associated with the discovery probe.

In some implementations, techniques 300 and/or 400 can be configured to operate on a subset of step types. For example, it may be desirable to not use technique 300, technique 400, or a combination thereof on certain steps or operations, such as those that may not be suitable for caching or reuse. In such an implementation, steps matching certain step types or included in a set of types for which techniques 300 and/or 400 are not suitable may be invoked and information returned to the server without caching or a determination of hash matching.

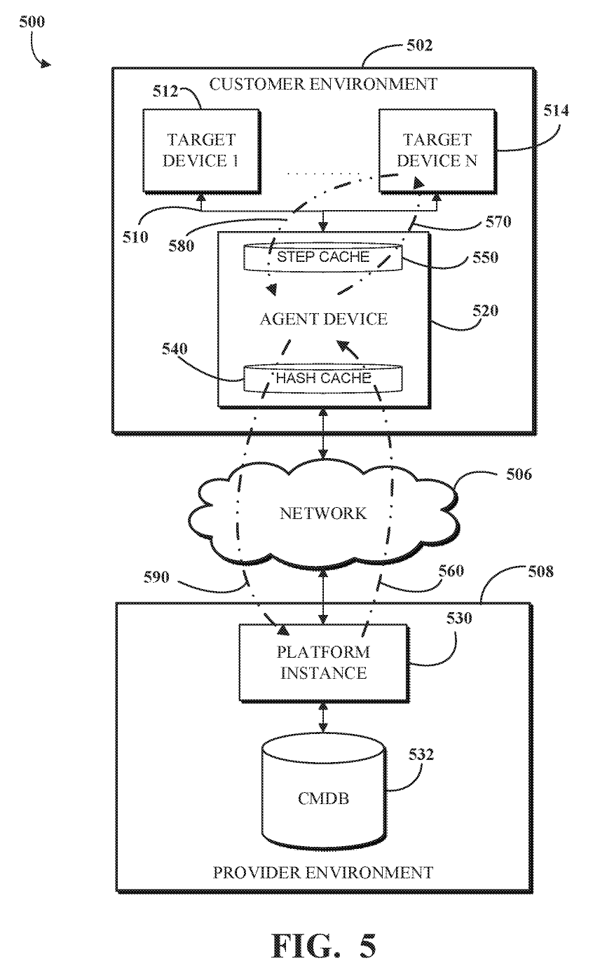

FIG. 5 illustrates a discovery probe of a target device being effected to update a network model in an example electronic computing and communications system 500. The system 500 includes a customer environment 502 that may communicate, via a network 506 (e.g., the Internet or some other wide area network), with a provider environment 508. Devices and software in the provider environment 508 may be used to provide management functions for network resources in the customer environment 502.

The customer environment 502 may include a number of devices connected by a customer network 510 (e.g., a firewalled local area network), including, for example, a target device 1 512 through a target device N 514 and an agent device 520. The provider environment 508 may include a platform instance 530 (e.g., running on a server device) and a CMDB 532 (e.g., running on a database server). The platform instance 530 may manage the network resources in the customer environment 502. The CMDB 532 may store models of the network resources in the customer environment 502, including configuration items for target devices (e.g., the target device N 514) in the customer environment 502.

The agent device 520 may include a hash cache 540 and a step cache 550 for processing discovery probes of target devices. In some implementations, the agent device 520 may itself be a target of discovery probes. In some implementations, the agent device 520 is a computing device 200 with a structure described in relation to FIG. 2.

In this example, a discovery probe is initiated against the target device N 514 when a discovery probe command 560 is transmitted by the platform instance 530 and received by the agent device 520. The command 560 may identify the discovery probe to be invoked and identify the target device N 514. The agent device 520 may then invoke the discovery probe 570 against the target device N 514, and resulting discovery probe data 580 may be in part received from the target device N 514 and in part retrieved from the step cache 550 (e.g., retrieving step results stored in the step cache 550 that have not expired). The agent device 520 may then determine a hash value based on the discovery probe data 580 and determine whether the new hash value matches the last hash value for the same discovery probe 570 and same target device N 514 that has been stored in the hash cache 540. In the event of a match, the agent device 520 transmits an indication of no change 590 to the platform instance 530 running on a server device in the provider environment 508. The indication of no change 590 may identify the discovery probe 570 and the target device N 514 and/or it may identify the command 560. In this example, the indication of no change 590 omits the rest of the discovery probe data 580 to conserve network resources. In some implementations, the platform instance 530 may update a configuration item, corresponding to the target device N 514, stored in the CMDB 532 to indicate that it is current to a time associated with the indication of no change 590.

In some implementations, portions of the hash cache 540, step cache 550, or combinations thereof may be implemented in a file system storage in a portion of memory that may be slower (e.g., hard disk memory) to reduce memory usage in portions of memory that may be faster (e.g., DRAM) but that may have constrained space.

FIG. 6 depicts a memory map 600 showing an example format for a record 610 stored in a cache for discovery probe data. The record 610 may include a discovery probe identifier 620 (e.g., a unique name for the discovery probe) and a device identifier 630 (e.g., a MAC address or a unique name for the device) for the target device against which the discovery probe was invoked to generate the record 610. The record may also include a hash value 640 that was determined based on the probe data that resulted when the identified discovery probe was invoked against the identified target device.

FIG. 7 depicts a memory map 700 showing an example format for a record 710 stored in a cache for results of discovery probe steps (i.e., a step cache). The record 710 may include a discovery step identifier 720 (e.g., a unique name for the discovery step) and a device identifier 730 (e.g., a MAC address or a unique name for the device) for the target device against which the discovery step was invoked to generate the record 710. The record 710 may also include a step result 740 (e.g., a port number for a service running on the device) that was received from the identified target device when the identified discovery step was last invoked against the identified target device.

The record 710 may include a time to live 750. The time to live 750 may specify how long the step result 740 should remain available for retrieval from the step cache. The time to live 750 may vary among different records. For example, the time to live 750 used for a record 710 in the step cache may be determined based on the specific discovery step identified or type of discovery step. In some implementations, the time to live 750 used for a record 710 in the step cache may be determined based on the specific target device identified or type of target device. The record 710 may include a timestamp 760 that specifies when the identified discovery step was invoked against the identified target device to determine the step result 740. The timestamp 760 may be used in conjunction with the time to live 750 to determine whether a record has expired and should be considered unavailable for retrieval and/or deleted. For example, the time to live 750 may be added to the timestamp 760 to determine an expiration time, which may be compared to the current time on an agent device. In some implementations (not shown in FIG. 7), the time to live 750 may be stored as an expiration time or in some other equivalent format from which expiration can be determined based upon comparison to a current time or some other metric. In some implementations, the step cache may include a module configured to periodically search for and delete records that have expired (i.e., exceeded their specified time to live 750 in the step cache).

The step cache may also be used for recording the results being returned from a discovered device onto a file or a table that will hold all those results. Later, these recordings may be returned by the step cache in order to simulate an actual device returning results. This solution may be leveraged for testing environments and to gap situations where a discovered target device only exists in a customer environment, but the discovery probe is part of an out-of-the-box product.

All or a portion of aspects of the systems and methods described herein can be implemented using a general-purpose computer/processor with a computer program that, when executed, carries out any of the respective techniques, algorithms, and/or instructions described herein. In addition, or alternatively, for example, a special-purpose computer/processor can be utilized which can contain specialized hardware for carrying out any of the techniques, algorithms, or instructions described herein.

The implementations of computing devices as described herein (and the algorithms, methods, instructions, etc., stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination.

For example, one or more computing devices can include an ASIC or programmable logic array (e.g., a field-programmable gate array (FPGA)) configured as a special-purpose processor to perform one or more of the operations described or claimed herein. An example FPGA can include a collection of logic blocks and random access memory (RAM) blocks that can be individually configured and/or configurably interconnected in order to cause the FPGA to perform certain functions. Certain FPGAs can contain other general-purpose or special-purpose blocks as well. An example FPGA can be programmed based on a hardware definition language (HDL) design, such as VHSIC Hardware Description Language or Verilog.

The embodiments disclosed herein can be described in terms of functional block components and various processing operations. Such functional block components can be realized by any number of hardware and/or software components that perform the specified functions. For example, the described embodiments can employ various integrated circuit components (e.g., memory elements, processing elements, logic elements, look-up tables, and the like), which can carry out a variety of functions under the control of one or more microprocessors or other control devices. Similarly, where the elements of the described embodiments are implemented using software programming or software elements, the systems and methods can be implemented with any programming or scripting language, such as C, C++, Java, assembler, or the like, with the various algorithms being implemented with any combination of data structures, objects, processes, routines or other programming elements. Functional aspects can be implemented in algorithms that execute on one or more processors. Furthermore, the embodiments of the systems and methods could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

Implementations or portions of implementations of the above disclosure can take the form of a computer program product accessible from, for example, a computer-usable or computer-readable medium. A computer-usable or computer-readable medium can be any device that can, for example, tangibly contain, store, communicate, or transport a program or data structure for use by or in connection with any processor. The medium can be, for example, an electronic, magnetic, optical, electromagnetic, or semiconductor device. Other suitable mediums are also available. Such computer-usable or computer-readable media can be referred to as non-transitory memory or media, and can include RAM or other volatile memory or storage devices that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

The word “example” is used herein to mean serving as an example, instance, or illustration. Any aspect or design described herein as “example” is not necessarily to be construed as preferred or advantageous over other aspects or designs. Rather, the use of the word “example” is intended to present concepts in a concrete fashion. The use of any and all examples, or language suggesting that an example is being described (e.g., “such as”), provided herein is intended merely to better illuminate the systems and techniques and does not pose a limitation on the scope of the systems and techniques unless otherwise claimed. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof. For example, if X includes A; X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this application and the appended claims is not intended to mean the same embodiment or implementation unless described as such.

The particular implementations shown and described herein are illustrative examples of the systems and methods and are not intended to otherwise limit the scope of the systems and methods in any way. For the sake of brevity, conventional electronics, control systems, software development, and other functional aspects of the systems (and components of the individual operating components of the systems) cannot be described in detail. Furthermore, the connecting lines, or connectors, shown in the various figures presented are intended to represent example functional relationships and/or physical or logical couplings between the various elements. Many alternative or additional functional relationships, physical connections, or logical connections can be present in a practical device.

The use of the terms “including,” “comprising,” “having,” and variations thereof herein is meant to encompass the items listed thereafter and equivalents thereof as well as additional items. Unless specified or limited otherwise, the terms “mounted,” “connected,” “supported,” “coupled,” and variations thereof are used broadly and encompass both direct and indirect mountings, connections, supports, and couplings. Further, “connected” and “coupled” are not restricted to physical or mechanical connections or couplings.

Unless otherwise indicated herein, the recitation of ranges of values herein is intended merely to serve as a shorthand alternative to referring individually to separate values falling within the range, and the separate values are individually incorporated into the specification as if they were individually recited herein. Finally, the operations of all methods described herein are performable in any suitable order unless otherwise indicated herein or clearly indicated otherwise by the context.

All references, including publications, patent applications, and patents, cited herein are hereby incorporated by reference to the same extent as if each individual reference were individually and specifically indicated as incorporated by reference and were set forth in its entirety herein.

The above-described embodiments have been described in order to facilitate easy understanding of the present systems and methods, and such descriptions do not limit the present systems and methods. To the contrary, the systems and methods are intended to cover various modifications and equivalent arrangements included within the scope of the appended claims, which scope is to be accorded the broadest interpretation as is permitted under the law so as to encompass all such modifications and equivalent arrangements.

What is claimed is:

1. A system for transmission of discovery probe data to a server device, the system comprising:
one or more memory components configured to store data and executable routines; and
one or more processor components configured to execute one or more routines stored on the memory components, wherein the routines, when executed cause the system to:
invoke a discovery probe against a device to obtain probe data, wherein the device is a member of a managed network of devices;
determine a hash value based at least in part on the probe data;
compare the hash value to a stored hash value, wherein the stored hash value was generated from a previous response to the discovery probe against the device; and
based upon the comparison:
if it is determined that the hash value matches the stored hash value, transmit an indication of no change to the server device; or
if it is determined that the hash value does not match the stored hash value, transmit the probe data to the server device and replace the stored hash value with the hash value.

2. The system of claim 1, wherein the one or more memory components store routines executable by the processor to:
retrieve a first result of a first step of the discovery probe from a cache storing results of discovery steps instead of invoking the first step against the device; and
invoke a second step of the discovery probe against the device.

3. The system of claim 2, wherein the one or more memory components store routines executable by the processor to:
store, in the cache storing results of discovery steps, a second result of invoking the second step of the discovery probe against the device, wherein the second result is associated with a time to live, after which the second result will no longer be available for retrieval.

4. The system of claim 3, wherein the cache storing results of discovery probe steps is configured to:
use a first time to live for results of the first step; and
use a second time to live, which is different from the first time to live, for results of the second step.

5. The system of claim 3, wherein the cache storing results of discovery probe steps is configured to:
use a first time to live for results of the first step when invoked against the device; and
use a second time to live, which is different from the first time to live, for results of the first step when invoked against a different device.

6. The system of claim 1, wherein the one or more memory components store routines executable by the processor to:
invoke a hash table look-up, using a key that is based on an identifier of the discovery probe and an identifier of the device, in order to retrieve the stored hash value for comparison to the hash value.

7. The system of claim 1, wherein the stored hash value is based in part on an identifier of the discovery probe and an identifier of the device.

8. The system of claim 1, wherein the one or more memory components store routines executable by the processor to:
receive, from the server device, a command to initiate the discovery probe.

9. The system of claim 1, wherein the one or more memory components store routines executable by the processor to:
invoke every step of the discovery probe against the device.

10. The system of claim 1, wherein the one or more memory components and the one or more the processor components are disposed within a customer environment and the server device is disposed within a provider environment.

11. A method for transmission of discovery probe data to a server device, the method comprising:
invoking a discovery probe against a device to obtain probe data, wherein the device is a member of a managed network of devices;
determining a hash value based at least in part on the probe data;
comparing the hash value to a stored hash value, wherein the stored hash value was generated from a previous response to the discovery probe against the device;
based upon the comparison:
determining that a match has occurred, where the hash value matches the stored hash value; and
responsive to the match, transmitting an indication of no change to the server device.

12. The method of claim 11, wherein invoking the discovery probe against the device comprises:
retrieving a first result of a first step of the discovery probe from a cache storing results of discovery steps instead of invoking the first step against the device; and
invoking a second step of the discovery probe against the device.

13. The method of claim 12, wherein invoking the discovery probe against the device comprises:
storing, in the cache storing results of discovery steps, a second result of invoking the second step of the discovery probe against the device, wherein the second result is associated with a time to live, after which the second result will no longer be available for retrieval.

14. The method of claim 13, wherein the cache storing results of discovery probe steps is configured to:
use a first time to live for results of the first step; and
use a second time to live, which is different from the first time to live, for results of the second step.

15. The method of claim 13, wherein the cache storing results of discovery probe steps is configured to:
use a first time to live for results of the first step when invoked against the device; and
use a second time to live, which is different from the first time to live, for results of the first step when invoked against a different device.

16. The method of claim 11, comprising:
invoking the discovery probe against the device at a subsequent time to obtain a new probe data;
determining a new hash value based at least in part on the new probe data;
determining that a mismatch has occurred, where the stored hash value differs from the new hash value;
responsive to the mismatch, transmitting the new probe data to the server device; and
responsive to the mismatch, storing the new hash value, the stored new hash value associated with the discovery probe and the device.

17. The method of claim 11, wherein determining a match has occurred comprises:
invoking a hash table look-up, using a key that is based on an identifier of the discovery probe and an identifier of the device, in order to retrieve the stored hash value for comparison to the hash value.

18. The method of claim 11, wherein the stored hash value is based in part on an identifier of the discovery probe and an identifier of the device.

19. The method of claim 11, wherein the indication of no change is transmitted instead of the probe data.

20. The method of claim 11, wherein the server device is disposed in a provider environment and the device is disposed in a customer environment.

21. A system for transmission of discovery probe data to a server device, the system comprising:
a memory, a processor, and a network interface, wherein the memory stores instructions executable by the processor to:
invoke a first discovery probe against a first device at a first time to obtain first probe data;
determine a first hash value based at least in part on the first probe data; and
store the first hash value for later comparison to a hash value for a future probe data, the stored first hash value associated with the first discovery probe and the first device.

22. The system of claim 21, wherein the memory stores instructions executable by the processor to:
transmit, via the network interface, the first probe data to the server device.

23. The system of claim 21, wherein the memory stores instructions executable by the processor to:
retrieve a first result of a first step of the first discovery probe from a cache storing results of discovery steps instead of invoking the first step against the first device; and
invoke a second step of the first discovery probe against the first device.

24. The system of claim 23, wherein the memory stores instructions executable by the processor to:
store, in the cache storing results of discovery steps, a second result of invoking the second step of the first discovery probe against the first device, wherein the second result is associated with a time to live, after which the second result will no longer be available for retrieval.

25. The system of claim 24, wherein the cache storing results of discovery probe steps is configured to:
use a first time to live for results of the first step; and
use a second time to live, which is different from the first time to live, for results of the second step.

26. The system of claim 24, wherein the cache storing results of discovery probe steps is configured to:
use a first time to live for results of the first step when invoked against the first device; and
use a second time to live, which is different from the first time to live, for results of the first step when invoked against a second device.

27. The system of claim 21, wherein the memory stores instructions executable by the processor to:
invoke a hash table look-up, using a key that is based on an identifier of the first discovery probe and an identifier of the first device, in order to retrieve the first hash value for comparison to the hash value for the future probe data.

28. The system of claim 21, wherein the first hash value is based in part on an identifier of the first discovery probe and an identifier of the first device.

29. A system for reception of discovery probe data from an agent device, the system comprising:
a memory and a processor, wherein the memory stores instructions executable by the processor to:
transmit, to the agent device a command to initiate a discovery probe, wherein the command causes the agent device to:
invoke a discovery probe against a device to obtain probe data, wherein the device is a member of a network managed by the system;
determine and store a hash value based at least in part on the probe data so as to generate a stored hash value; and
transmit the probe data;
receive the probe data from the agent device;
at one or more subsequent times, transmit to the agent device a command to initiate the discovery probe, wherein the command issued at a subsequent time causes the agent device to:
invoke the discovery probe against the device at a subsequent time to obtain probe data at the subsequent time;
determine a current hash value based at least in part on the probe data at the subsequent time;
determine if a match has occurred between the stored hash value and the current hash value; and
based upon the determination transmitting either an indication of no change or the probe data acquired at the subsequent time; and
receive the indication of no change or the probe data acquired at the subsequent time from the agent device.

30. The system of claim 29, wherein the memory stores instructions executable by the processor to:
update a configuration item that corresponds to the device in a configuration management database based on the probe data.

31. The system of claim 29, wherein the memory stores instructions executable by the processor to:
update a configuration item that corresponds to the device in a configuration management database to indicate that the configuration item is current to a time associated with the indication of no change.
